(19) United States
(12) Patent Application Publication
(10) Pub. No.: US 2008/0236585 A1
(43) Pub. Date: Oct. 2, 2008

(54) INDICATING DEVICE FOR A VENTILATOR

(75) Inventors: Frederick A. Parker, Gwynedd Valley, PA (US); Mark P. Grady, Ambler, PA (US)

Correspondence Address: WILLIAM H. EILBERG, 316 CALIFORNIA AVE. #785, RENO, NV, 89509, US

(73) Assignee: CALDYNE INC., Willow Grove, PA (US)

(21) Appl. No.: 12/049,777

(22) Filed: Mar. 17, 2008

Related U.S. Application Data
(60) Provisional application No. 60/908,827, filed on Mar. 29, 2007.

(51) Int. Cl. A62B 9/00

(52) U.S. Cl. 128/205.23

(57) ABSTRACT

An indicating device assists rescue personnel in administering cardiopulmonary resuscitation (CPR). A transducer measures the pressure drop in a flow tube attached to the patient, and this pressure drop is converted into a flow rate and volume. Another transducer measures the pressure in the flow tube at a point near the patient, the measured pressure being essentially the same as, or related to, the intratracheal pressure. Indicator lights show either red or green or yellow, when the flow rate, and/or the intratracheal pressure, are within or outside of a preferred range. The desired ranges can be adjusted according to the weight of the patient. The device provides immediate guidance for rescue personnel, by indicating whether the volume of gas received by the patient is appropriate, and whether intratracheal pressure is below or above a potentially lethal level. It also provides a prompt light to indicate the desirable rate at which to administer respirations, a rate based upon the measured values of the exhaled volume and the intratracheal pressure.

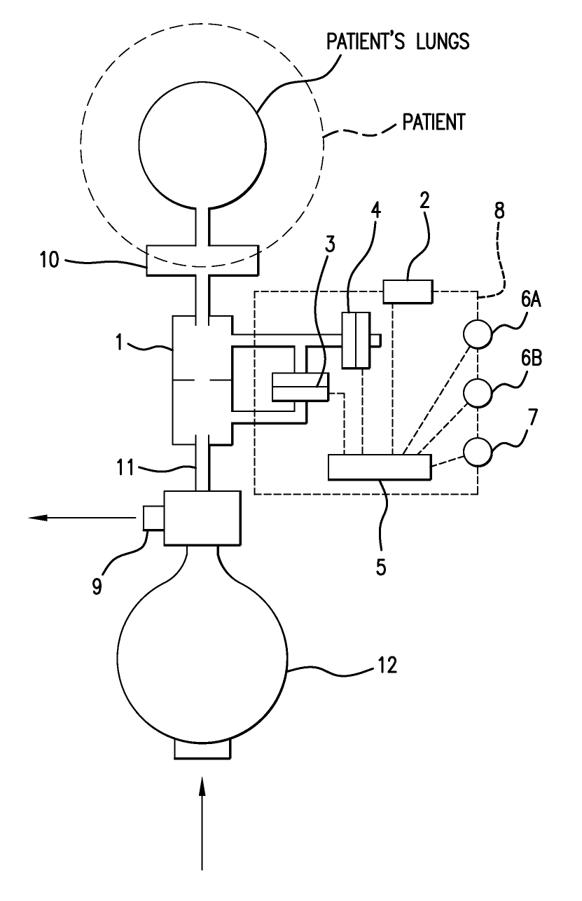

### CROSS-REFERENCE TO PRIOR APPLICATION

Priority is claimed from U.S. provisional patent application Ser. No. 60/908,827, filed Mar. 29, 2007, the disclosure of which is incorporated by reference herein.

### BACKGROUND OF THE INVENTION

The present invention relates to the field of ventilators used for rescue purposes, and provides an indicating device which enhances the ability of rescue personnel to save the life of a patient.

It is known to provide cardiopulmonary resuscitation (CPR) with a bag/mask ventilator (BVM), in which a mask is secured to the patient's face. Alternatively, the interface with the patient may be an intratracheal tube which is inserted into the patient's trachea, or an advanced airway. Squeezing the bag forces air or oxygen into the lungs of the patient. The bag is typically connected to a check valve arrangement which causes the patient's exhaled breath to be vented to the outside before the next injection of gas into the patient's lungs.

During the administration of CPR, it has been common for rescuers, when using bag/mask ventilators, to provide an excessive number of breaths, resulting in death of the patient. This problem is described in “Death by Hyperventilation: A common and life threatening problem during cardiopulmonary resuscitation”, by Aufderheide et al, Critical Care Medicine, Sep. 2, 2004. The identified cause of death has been that excessive ventilations cause the patient's intrathoracic pressure to increase, which, in turn, cause the coronary perfusion pressure to decrease to a point that the patient cannot be resuscitated.

To prevent death due to hyperventilation, the latest American Heart Association Guidelines specify 8 to 10 respirations per minute. However, at this low ventilation rate, there may be inadequate oxygenation of the blood if the tidal volumes actually received by the patient are inadequate, particularly if there is significant mask leakage. If the blood is inadequately oxygenated, all other interventions, no matter how skillfully performed, will not save the patient.

The present invention therefore provides a device which gives an easily readable indication of the effectiveness of the “pulmonary” part of CPR. Specifically, the device of the present invention guides rescue personnel, in real time, so that respirations are delivered at a desirable rate and volume, and so that intrathoracic pressure is held within an acceptable range.

### SUMMARY OF THE INVENTION

The device of the present invention includes a pressure transducer, connected to measure the pressure drop in a flow tube connected between a bag/mask ventilator (BVM) and the patient. From the measurement of such pressure drop versus time, the volume of gas exhaled by the patient may be measured. A second pressure transducer measures the gauge pressure in the flow tube immediately adjacent to the patient. The second transducer therefore effectively measures intratracheal pressure, as a surrogate for the intrathoracic pressure. The output of the transducers is connected to a microprocessor control device, which performs calculations based on inputs received from the transducers, and which controls displays which indicate, to the rescuer, whether the volume of gas exhaled by the patient is adequate and the resulting intratracheal pressure is sufficiently low. Separate displays may be used to indicate the appropriateness of the ventilation volume, the rate of ventilation, and the intratracheal pressure.

The microprocessor used in the present invention may be programmed to flash an indicator lamp, or to activate some other signalling means which can be intermittently actuated, at a frequency which guides the rescuer in administering CPR. In particular, the microprocessor may be programmed to reduce the frequency of flashing, if the measured flow volume is adequate but the intratracheal pressure is too high. Conversely, if the intratracheal pressure is sufficiently low, and the exhaled flow volume is inadequate, the microprocessor can increase the frequency of flashing. Then, as long as the rescuer administers CPR at the indicated rate, the risk to the patient is reduced.

The present invention therefore has the primary object of providing an indicating device which helps rescue personnel to perform the pulmonary portion of cardiopulmonary resuscitation (CPR) correctly.

The invention has the further object of reducing the risk of death to a patient undergoing CPR, by indicating whether or not the ventilations provided are causing too high an intratracheal pressure.

The invention has the further object of providing a simple and immediately understandable indication of the appropriate time to provide a breath.

The invention has the further object of providing a device which prompts the rescuer when to administer a breath, and which guides the rescuer as to a preferred frequency of administration of breaths.

The invention has the further object of providing a simple and immediately understandable indication of whether a patient undergoing CPR is receiving an adequate volume of gas.

The invention has the further object of providing an inexpensive indicating device, as described above, wherein the device can be used with existing bag/mask ventilators.

The invention has the further object of providing a method for enhancing the effectiveness, and reducing risk, during CPR.

The reader skilled in the art will recognize other objects and advantages of the present invention, from a reading of the following brief description of the drawings, the detailed description of the invention, and the appended claims.

### BRIEF DESCRIPTION OF THE DRAWINGS

The FIGURE provides a schematic diagram of a preferred embodiment of the device of the present invention.

### DETAILED DESCRIPTION OF THE INVENTION

In the preferred embodiment, the present invention comprises a device which is intended to be placed between the patient port of a bag/mask ventilator (BVM) and the patient mask (or endotracheal tube, or advanced airway), to measure the volume of the breath exhaled by the patient. The device then compares the measured volume to a minimum acceptable volume, based on the weight of the patient, and illuminates a green light if it is adequate, or a yellow light as a caution indicator, or a red light if it is not adequate.

Additionally, the device of the present invention measures the intratracheal pressure, and illuminates a green light if it is below an acceptable level, a yellow light as a warning, or a red light if it is above an acceptable level.

Furthermore, the device may include a flashing light, to prompt the rescuer to squeeze the bag. For example, by flashing at a rate of ten times per minute, the device prompts the rescuer to ventilate the patient at that rate. This function may be designed so that the color of the flashing light will indicate to the rescuer whether the respiration rate actually being provided is satisfactory. If it is satisfactory, the light may be green; if unsatisfactory, it may be red. If it is close to an unsatisfactory rate, the light may be yellow.

If desired, the flashing light frequency may be made a function of the weight entered. For example, if the patient is a child with perfusing rhythm, it may be desirable to administer a larger number of breaths, say 12 to 20.

If the measured expiratory flow volume is more than adequate, but the mean intratracheal pressure is too high, means may be provided to decrease the rate at which the prompt light flashes. This will have the effect of decreasing the mean intratracheal pressure without compromising the adequacy of the supplied volume of gas, provided that the rescuer ventilates the patient at the rate suggested by the flash rate. Conversely, if the mean intratracheal pressure is low, and the volume of gas exhaled by the patient is inadequate, then the frequency with which the prompt light flashes may be increased, guiding the rescuer to increase the frequency of ventilation.

Instead of a prompt light, one may use any other indicator capable of producing an intermittent signal at a controlled rate. For example, a buzzer or other sound may be used instead of a light. Such other indicators should be considered equivalents of the flashing light.

To use the device of the present invention, the rescuer will first turn the unit on, enter the weight of the patient, and then connect the device between the patient port of the BVM and the patient mask (or endotracheal (ET) tube).

The device may consist of two parts, the first being a single-patient-use flow tube which creates a pressure drop, and the second being an instrument which performs pressure measurements and calculations, and which provides indications to rescue personnel. The measured pressure drop is related to flow rate, which can be calculated by a microprocessor. One transducer measures the pressure drop and another transducer measures the intratracheal pressure. A microprocessor, which is preferably housed in the above-mentioned second part or instrument, receives data from the transducer, performs appropriate calculations, and generates control signals to various display devices, such as colored lights. The instrument is preferably removably attached to the flow tube.

The microprocessor located in the instrument portion therefore comprises means for comparing the expiratory flow with a minimally acceptable value, based on the weight of the patient, which is stored in memory. Likewise, the device of the present invention compares the mean measured intratracheal pressure with an upper limit value, also stored in memory. Based on the results of these comparisons, the device alerts the rescuer as to whether or not the pulmonary part of CPR is being performed correctly. Thus, the invention helps to prevent the rescuer from creating too much intratracheal pressure, or from supplying an inadequate tidal volume, as the bag is squeezed.

The microprocessor described above can also comprise the means for controlling the rate at which the light flashes (or the rate at which some other indicator delivers a signal). Control of the signalling rate can thus be one of the functions programmed into the microprocessor.

The instrument of the present invention is capable of doing much more than what is described above. Based on the data supplied by the two pressure transducers, the device can be programmed to calculate and display other parameters, such as minute volume, respiration rate, tidal volume, time-line intratracheal pressure, expiratory/inspiratory time ratio, etc. Also, the display need not take the form of lights, as described above, but may, for example, be an LCD. The device can also measure and compare the supplied volume with the expired volume (to look for mask leakage), etc. All of these, and other possibilities, will be evident to those skilled in the art.

The device of the invention may also include means to record the measured values, for subsequent download, or may transmit the information (or the raw pressure data) to a remote display (or instrument). However, the intent of the preferred embodiment, as described, is to measure the most critical parameters, and to keep the displays on the device as simple as possible, so that it will be of maximum use to the rescuer.

The FIGURE provides a diagram of the device of the present invention. Flow tube 1 is normally located, and connected, between the patient outlet fitting 11 of the BVM, and the patient mask (or ET tube or advanced airway) 10. Flow tube 1 contains means for creating a pressure drop, which is a function of the flow rate of the gas flowing from the mask (or ET tube) 10 to the exhalation port 9 of the BVM. This flow rate is the flow rate of the patient's exhaled breath. Pressure transducer 3 measures this pressure drop, created in flow tube 1, and sends the data to microprocessor control unit 5. From the measurement of the pressure drop versus time, the microprocessor can calculate the flow volume, and can compare the measured flow with a value stored in memory. The value with which the measured flow volume is compared is determined when the rescuer first enters the weight of the patient, using input device 2. Control unit 5 then illuminates the appropriate color of display 6A (either red or yellow or green, depending on the flow volume). In actuality, the device will average a number of breaths before changing color so that the displayed color will not change if occasional breaths fall outside the average value.

Pressure transducer 4 continuously measures the pressure at which the gas is flowing to the patient when bag 12 is squeezed by the rescuer, and from the patient as the patient exhales, including any pressure imposed by any form of PEEP or CPAP device. This pressure, or a mean pressure derived from the pressure versus time, is approximately equal to the mean intratracheal pressure, which is a surrogate for the mean intrathoracic pressure. Control unit 5 compares the measured pressure with a maximum acceptable level, and illuminates the appropriate colored light on display 6B, to indicate whether or not the intratracheal pressure is within an acceptable range.

Light 7 flashes, at a selected rate, to prompt the rescuer to squeeze the bag 12. This prompt light may be yellow. If the actual breath rate administered by the rescuer is within reasonable limits of the selected rate, based on measurements made by pressure transducer 4, and calculated by control unit 5, the control unit 5 may cause light 7 to flash in green. If the breath rate is outside those limits, the control unit may cause light 7 to flash in red. If the breath rate is within the desired limit, but close to the boundary of such limit, the light may flash in yellow. Although the above arrangement is preferred, other color schemes for the lights could be used, within the scope of the invention.

Components 2-7 are preferably contained within housing 8.

The invention can be modified in many ways. For example, the means for creating the pressure drop may be contained within the BVM device itself, and not necessarily in a separate flow tube; and the display means can be changed from a flashing light to some other indicator, such as a sound, a video display, or some combination of the above. Such modifications, which will be apparent to those skilled in the art, should be considered to be within the spirit and scope of the following claims.

What is claimed is:

1. An indicating device for assisting rescue personnel in the administration of cardiopulmonary resuscitation of a patient, the patient being connected, by a flow tube, to a bag/mask ventilator, the indicating device comprising:
a) a first pressure transducer connected to measure pressures in distinct locations in the flow tube,
b) the first pressure transducer being connected to a microprocessor which is programmed to convert pressures measured by the transducer into a flow rate and volume of gas in the flow tube,
c) the microprocessor being connected to a display for indicating whether the flow is within an acceptable range, and
d) a second pressure transducer, connected to measure intratracheal pressure of the patient,
e) the second pressure transducer also being connected to the microprocessor, the microprocessor being connected to a second display for indicating whether the intratracheal pressure is within an acceptable range.

2. The indicating device of claim 1, wherein the device includes a prompt light, and wherein the microprocessor comprises means for flashing the prompt light at a controlled rate.

3. The indicating device of claim 2, wherein the microprocessor is programmed to decrease said rate of flashing if the measured flow volume is adequate and if the intratracheal pressure is too high, and wherein the microprocessor is programmed to increase said rate if the intratracheal pressure is low and the measured volume is inadequate.

4. The indicating device of claim 1, further comprising means for entering data relating to a weight of the patient, wherein the microprocessor is programmed to determine an acceptable range of flow according to said data relating to weight.

5. An indicating device for assisting rescue personnel in the administration of cardiopulmonary resuscitation of a patient, the patient being connected, by a flow tube, to a bag/mask ventilator, the indicating device comprising:
a) means for measuring gas flow in the flow tube,
b) means for determining whether a measured gas flow in the flow tube is within a predetermined range, and for indicating whether said gas flow is within said predetermined range,
c) means for measuring gas pressure at a location in the flow tube, the measured gas pressure being related to intratracheal pressure of the patient, and
d) means for determining whether the measured gas pressure is within a predetermined range, and for indicating whether said gas pressure is within said predetermined range.

6. The indicating device of claim 5, further comprising means for inputting a weight of the patient, wherein the weight inputting means is connected to the flow determining means, wherein the predetermined flow is adjusted according to the weight of the patient.

7. The indicating device of claim 5, wherein the device includes an indicator capable of delivering an intermittent signal at a controlled rate, and means for controlling said indicator.

8. The indicating device of claim 7, wherein the controlling means is programmed to decrease said rate if the measured flow is adequate and if the measured intratracheal pressure is too high, and wherein the controlling means is programmed to increase said rate if the intratracheal pressure is low and the measured flow is inadequate.

9. A method for assisting rescue personnel in the administration of cardiopulmonary resuscitation to a patient, the method comprising:
a) measuring a flow of gas in a flow tube connected to the patient, and activating a display indicative of whether a measured flow is within a desirable range,
b) measuring gas pressure in the flow tube, and activating a display indicative of whether a measured gas pressure is within a desirable range.

10. The method of claim 9, wherein step (a) is preceded by entering data relating to a weight of the patient, and wherein the desirable range used in step (a) is adjusted according to said entered data.

11. The method of claim 9, wherein the steps of the method are performed continuously.

12. The method of claim 9, further comprising actuating an indicator capable of producing a signal at a controlled rate, and selecting said rate according to a desired frequency of breathing.

13. The method of claim 12, wherein the method includes decreasing said frequency of breathing if the measured flow is adequate and if the measured pressure is too high, and increasing said frequency of breathing if the pressure is low and the measured flow is inadequate.
